(19) United States
(12) Patent Application Publication
(10) Pub. No.: US 2023/0142742 A1
(43) Pub. Date: May 11, 2023

(54) DETERMINING MULTIPHASE FLUID FLOW PROPERTIES

(71) Applicant: Saudi Arabian Oil Company, Dhahran (SA)

(72) Inventors: Tao Lin, Katy, TX (US); Weichang Li, Katy, TX (US); Muhammad Arsalan, Dhahran (SA)

(21) Appl. No.: 17/983,037

(22) Filed: Nov. 8, 2022

Related U.S. Application Data
(60) Provisional application No. 63/277,022, filed on Nov. 8, 2021.

(51) Int. Cl. G01F 1/74; G01F 1/667

(52) U.S. Cl. CPC G01F 1/74; G01F 1/667

(57) ABSTRACT

Techniques include flowing a multiphase fluid from a hydrocarbon production well through a conduit; measuring, with an ultrasonic tomographic multiphase flow meter (UMM), ultrasonic waveforms generated by the UMM from the multiphase fluid; measuring properties of the multiphase fluid with fluid measurement sensors coupled to the conduit; identifying the ultrasonic waveforms and the properties with a machine-learning control system; determining multiphase fractions of the multiphase fluid from the one or more ultrasonic waveforms with a first ML model; determining a total flow rate of the multiphase fluid from the measured properties of the multiphase fluid with a second ML model; and determining a volumetric flow rate of a liquid phase or a gas phase based on the determined multiphase fraction and the determined total flow rate.

### CROSS-REFERENCE TO RELATED APPLICATION

This application claims priority under 35 U.S.C. § 119 to U.S. Provisional Patent Application Ser. No. 63/277,022, filed on Nov. 8, 2021, the entire contents of which are incorporated by reference herein.

### TECHNICAL FIELD

The present disclosure describes apparatus, systems, and methods for determining multiphase fluid flow properties.

### BACKGROUND

Multiphase fluid flow, such as a fluid flow with a combination of oil, gas, and water, is frequently encountered in the exploitation of oil and natural gas. Determining the individual phase flow rate of multiphase flow is important for optimizing the performance of oil well production and enhancing oil recovery. However, the complex flow structure and interfacial effect have made the accurate direct measurement a challenging problem.

### SUMMARY

In an example implementation, a well system includes a conduit configured to flow a multiphase fluid from a hydrocarbon production well to or on a terranean surface, the multiphase fluid includes at least one of a liquid phase or a gas phase; an ultrasonic tomographic multiphase flow meter (UMM) fluidly coupled to the conduit to receive the multiphase fluid there through; one or more fluid measurement sensors positioned to measure one or more properties of the multiphase fluid; and a machine-learning (ML) control system that includes at least one hardware processor operable to execute instructions stored on a tangible, non-transitory memory to perform operations. The operations include (i) identifying one or more ultrasonic waveforms generated by the UMM from the multiphase fluid; (ii) identifying measured properties of the multiphase fluid from the one or more fluid measurement sensors; (iii) determining multiphase fractions of the multiphase fluid from the one or more ultrasonic waveforms with a first ML model; (iv) determining a total flow rate of the multiphase fluid from the measured properties of the multiphase fluid with a second ML model; and (v) determining a volumetric flow rate of the at least one of the liquid phase or the gas phase based on the determined multiphase fraction and the determined total flow rate.

In an aspect combinable with the example implementation, the liquid phase includes a water phase and an oil phase.

In another aspect combinable with any of the previous aspects, the second ML model includes a virtual flow meter model.

In another aspect combinable with any of the previous aspects, the operation (iv) includes predicting the total flow rate with the virtual flow meter model based on the measured properties of the multiphase fluid.

In another aspect combinable with any of the previous aspects, the virtual flow meter model includes an ML trained model from historical measured flow rates of the multiphase fluid and historical properties of the multiphase fluid measured by the one or more fluid measurement sensors.

In another aspect combinable with any of the previous aspects, the operation (iii) includes determining a liquid fraction of the liquid phase based at least in part on a sound velocity profile of the multiphase fluid determined from the one or more ultrasonic waveforms with the first ML model; and determining a void fraction of the gas phase based at least in part on the one or more ultrasonic waveforms with the first ML model.

In another aspect combinable with any of the previous aspects, the operation of determining the void fraction includes predicting the void fraction based on a flow regime of the multiphase fluid with the first ML model.

In another aspect combinable with any of the previous aspects, the operations further include correlating the liquid fraction and the void fraction based on the flow regime of the multiphase fluid to correct the determined liquid and gas fractions.

In another aspect combinable with any of the previous aspects, the determined liquid fraction includes a water cut of the multiphase fluid.

In another aspect combinable with any of the previous aspects, the operations further include correcting an estimated volumetric flow rate of the liquid phase and an estimate of volumetric flow rate of the gas phase with a third ML model to determine the volumetric flow rate of the liquid phase and the gas phase.

In another aspect combinable with any of the previous aspects, the operation of correcting the estimated volumetric flow rate of the liquid phase and an estimate of volumetric flow rate of the gas phase includes using the third ML model to correct the estimated volumetric flow rates based at least in part on a superficial velocity of the multiphase fluid.

In another example implementation, a method includes flowing a multiphase fluid from a hydrocarbon production well through a conduit, the multiphase fluid including at least one of a liquid phase or a gas phase; measuring, with an ultrasonic tomographic multiphase flow meter (UMM) fluidly coupled to the conduit, one or more ultrasonic waveforms generated by the UMM from the multiphase fluid; measuring one or more properties of the multiphase fluid with one or more fluid measurement sensors coupled to the conduit; identifying the one or more ultrasonic waveforms and the one or more properties with a machine-learning (ML) control system that includes at least one hardware processor operable to execute instructions stored on a tangible, non-transitory memory; determining, with the ML control system, multiphase fractions of the multiphase fluid from the one or more ultrasonic waveforms with a first ML model; determining, with the ML control system, a total flow rate of the multiphase fluid from the measured properties of the multiphase fluid with a second ML model; and determining, with the ML control system, a volumetric flow rate of the at least one of the liquid phase or the gas phase based on the determined multiphase fraction and the determined total flow rate.

In an aspect combinable with the example implementation, the liquid phase includes a water phase and an oil phase.

In another aspect combinable with any of the previous aspects, the second ML model includes a virtual flow meter model.

In another aspect combinable with any of the previous aspects, determining, with the ML control system, the total flow rate of the multiphase fluid includes predicting, with the ML control system, the total flow rate with the virtual flow meter model based on the measured properties of the multiphase fluid.

In another aspect combinable with any of the previous aspects, the virtual flow meter model includes an ML trained model from historical measured flow rates of the multiphase fluid and historical properties of the multiphase fluid measured by the one or more fluid measurement sensors.

In another aspect combinable with any of the previous aspects, determining, with the ML control system, multiphase fractions of the multiphase fluid includes determining, with the ML control system, a liquid fraction of the liquid phase based at least in part on a sound velocity profile of the multiphase fluid determined from the one or more ultrasonic waveforms with the first ML model; and determining, with the ML control system, a void fraction of the gas phase based at least in part on the one or more ultrasonic waveforms with the first ML model.

In another aspect combinable with any of the previous aspects, determining the void fraction includes predicting the void fraction based on a flow regime of the multiphase fluid with the first ML model.

Another aspect combinable with any of the previous aspects further includes correlating, with the ML control system, the liquid fraction and the void fraction based on the flow regime of the multiphase fluid to correct the determined liquid and gas fractions.

In another aspect combinable with any of the previous aspects, the determined liquid fraction includes a water cut of the multiphase fluid.

Another aspect combinable with any of the previous aspects further includes correcting an estimated volumetric flow rate of the liquid phase and an estimate of volumetric flow rate of the gas phase with a third ML model to determine the volumetric flow rate of the liquid phase and the gas phase.

In another aspect combinable with any of the previous aspects, correcting the estimated volumetric flow rate of the liquid phase and an estimate of volumetric flow rate of the gas phase includes using the third ML model to correct the estimated volumetric flow rates based at least in part on a superficial velocity of the multiphase fluid.

In another example implementation, an apparatus including a tangible, non-transitory computer-readable media that includes instructions operable, when executed by one or more hardware processors, to cause the one or more hardware processors to perform operations including identifying one or more ultrasonic waveforms generated by an ultrasonic tomographic multiphase flow meter (UMM) from a multiphase fluid that includes at least one of a liquid phase or a gas phase; identifying measured properties of the multiphase fluid from the one or more fluid measurement sensors; determining multiphase fractions of the multiphase fluid from the one or more ultrasonic waveforms with a first ML model; determining a total flow rate of the multiphase fluid from the measured properties of the multiphase fluid with a second ML model; and determining a volumetric flow rate of the at least one of the liquid phase or the gas phase based on the determined multiphase fraction and the determined total flow rate.

In an aspect combinable with the example implementation, the liquid phase includes a water phase and an oil phase.

In another aspect combinable with any of the previous aspects, the second ML model includes a virtual flow meter model.

In another aspect combinable with any of the previous aspects, the operation (iv) includes predicting the total flow rate with the virtual flow meter model based on the measured properties of the multiphase fluid.

In another aspect combinable with any of the previous aspects, the virtual flow meter model includes an ML trained model from historical measured flow rates of the multiphase fluid and historical properties of the multiphase fluid measured by the one or more fluid measurement sensors.

In another aspect combinable with any of the previous aspects, the operation (iii) includes determining a liquid fraction of the liquid phase based at least in part on a sound velocity profile of the multiphase fluid determined from the one or more ultrasonic waveforms with the first ML model; and determining a void fraction of the gas phase based at least in part on the one or more ultrasonic waveforms with the first ML model.

In another aspect combinable with any of the previous aspects, the operation of determining the void fraction includes predicting the void fraction based on a flow regime of the multiphase fluid with the first ML model.

In another aspect combinable with any of the previous aspects, the operations further include correlating the liquid fraction and the void fraction based on the flow regime of the multiphase fluid to correct the determined liquid and gas fractions.

In another aspect combinable with any of the previous aspects, the determined liquid fraction includes a water cut of the multiphase fluid.

In another aspect combinable with any of the previous aspects, the operations further include correcting an estimated volumetric flow rate of the liquid phase and an estimate of volumetric flow rate of the gas phase with a third ML model to determine the volumetric flow rate of the liquid phase and the gas phase.

In another aspect combinable with any of the previous aspects, the operation of correcting the estimated volumetric flow rate of the liquid phase and an estimate of volumetric flow rate of the gas phase includes using the third ML model to correct the estimated volumetric flow rates based at least in part on a superficial velocity of the multiphase fluid.

Implementations of methods and systems for determining multiphase fluid flow properties according to the present disclosure may include one or more of the following features. For example, implementations according to the present disclosure can provide for a robust metering workflow and advanced machine learning based data analytics system that allows an enhanced operational envelop of multiphase flow metering. As another example, implementations according to the present disclosure can provide for machine learning (ML) virtual flow metering. As another example, implementations according to the present disclosure can provide for a robust estimation of oil/gas/water multiphase flow phase fractions with an ML approach. As a further example, implementations according to the present disclosure can provide for a robust estimation of oil/gas/water multiphase flow volumetric rates with an ML approach. As a further example, implementations according to the present disclosure can provide for a real-time insight into the multiphase flow pattern and help the operators to monitor the production. In addition, implementations according to the present disclosure can forecast the flow rates estimation for production planning.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of a well system with a multiphase flow meter and ML control system according to the present disclosure.

FIG. 2 is a schematic illustration of the ML control system of FIG. 1 according to the present disclosure.

FIG. 3 is a schematic illustration of a workflow for an ML based multiphase flow metering process according to the present disclosure.

FIG. 4 is a graph that shows measurements of ultrasonic waveforms through transducer pairs of an ultrasonic tomographic multiphase flow meter according to the present disclosure.

FIG. 5 is a schematic illustration showing the waveforms and reflections of FIG. 4 according to the present disclosure.

FIG. 6 is a graph that shows travel time estimates for transducer pairs of the ultrasonic tomographic multiphase flow meter according to the present disclosure.

FIG. 7 is an image that shows an inversion of a sound velocity profile computed from the travel time estimates according to the present disclosure.

FIG. 8 is a graph that shows water cut vs. velocity of a multiphase fluid flow according to the present disclosure.

FIG. 9 shows graphs of ultrasonic sensor pulse signals to characterize flow patterns in a multiphase fluid flow according to the present disclosure.

FIG. 10 is a schematic illustration of a virtual multiphase flow meter according to the present disclosure.

FIG. 11 is a schematic illustration of an ML training architecture according to the present disclosure.

FIG. 12 is a graph of predicted liquid flow rate in a multiphase fluid flow from a virtual flow meter according to the present disclosure.

FIG. 13 is a schematic illustration of gas volumetric flux relative to liquid volumetric flux in a multiphase fluid flow and resultant flow regimes according to the present disclosure.

FIG. 14 is a graph that illustrates water-oil fraction correction under gas flow rate according to the present disclosure.

FIG. 15 is a graph that illustrates cross-sectional water-cut fraction and volumetric flow fraction according to the present disclosure.

FIG. 16. is a graph that illustrates an estimation of volumetric flow rates according to the present disclosure.

FIG. 17 is a flowchart that illustrates an example method for determining properties of a multiphase fluid flow according to the present disclosure.

FIG. 18 is a schematic illustration of an example controller (or control system) for determining properties of a multiphase fluid flow according to the present disclosure.

### DETAILED DESCRIPTION

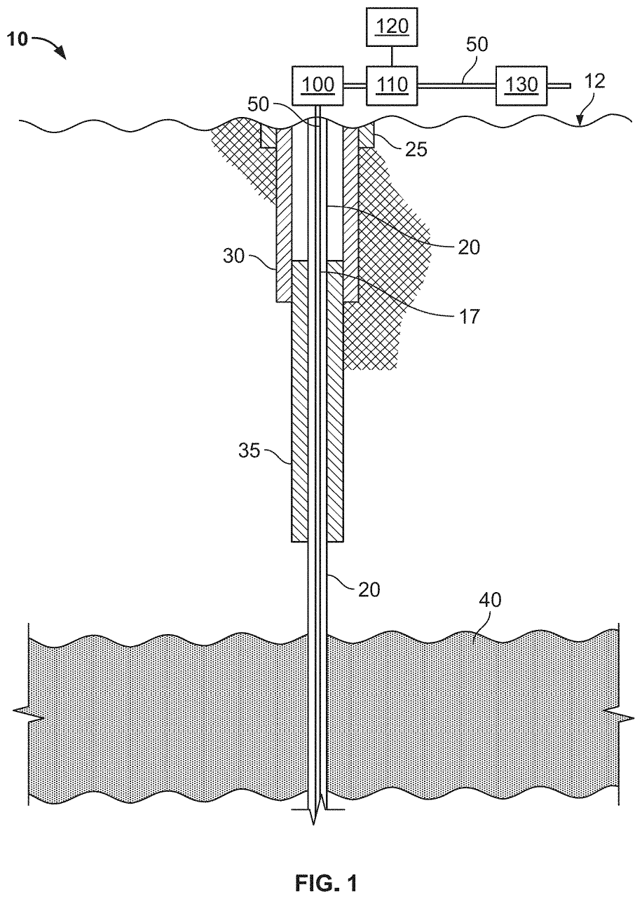

FIG. 1 is a schematic diagram of well system 10 that includes a multiphase flow meter 110 and machine-learning (ML) control system 120 according to the present disclosure. Generally, FIG. 1 illustrates a portion of an example embodiment of a well system 10 according to the present disclosure in which a multiphase fluid, such as a wellbore fluid comprised of one or more of oil, gas, and water, flows through the multiphase flow meter 110 and is analyzed for fractional flow rates and velocities by the ML control system 120 using one or more ML models. For example, the ML control system 120, in combination with the multiphase flow meter 110 can execute for a robust metering workflow and advanced ML-based data analytics system that creates an ML virtual flow metering system, a robust estimation of oil/gas/water multiphase flow phase fractions with an ML approach, and a robust estimation of oil/gas/water multiphase flow volumetric rates with an ML approach.

As shown, the well system 10 accesses a subterranean formation 40 and provides access to hydrocarbons located in such subterranean formation 40. In an example implementation of system 10, the system 10 may be used for a production operation in which the hydrocarbons may be produced from the subterranean formation 40 within the wellbore tubular 17 (for example, as a production tubing or casing). However, tubular 17 may represent any tubular member positioned in the wellbore 20 such as, for example, coiled tubing, any type of casing, a liner or lining, another downhole tool connected to a work string (in other words, multiple tubulars threaded together), or other form of tubular member.

A drilling assembly (not shown) may be used to form the wellbore 20 extending from the terranean surface 12 and through one or more geological formations in the Earth. One or more subterranean formations, such as subterranean zone 40, are located under the terranean surface 12. As will be explained in more detail below, one or more wellbore casings, such as a surface casing 30 and intermediate casing 35, may be installed in at least a portion of the wellbore 20. In some embodiments, a drilling assembly used to form the wellbore 20 may be deployed on a body of water rather than the terranean surface 12. For instance, in some embodiments, the terranean surface 12 may be an ocean, gulf, sea, or any other body of water under which hydrocarbon-bearing formations may be found. In short, reference to the terranean surface 12 includes both land and water surfaces and contemplates forming and developing one or more well systems 10 from either or both locations.

In some embodiments of the well system 10, the wellbore 20 may be cased with one or more casings. As illustrated, the wellbore 20 includes a conductor casing 25, which extends from the terranean surface 12 shortly into the Earth. A portion of the wellbore 20 enclosed by the conductor casing 25 may be a large diameter borehole. Additionally, in some embodiments, the wellbore 20 may be offset from vertical (for example, a slant wellbore). Even further, in some embodiments, the wellbore 20 may be a stepped wellbore, such that a portion is drilled vertically downward and then curved to a substantially horizontal wellbore portion. Additional substantially vertical and horizontal wellbore portions may be added according to, for example, the type of terranean surface 12, the depth of one or more target subterranean formations, the depth of one or more productive subterranean formations, or other criteria.

Downhole of the conductor casing 25 may be the surface casing 30. The surface casing 30 may enclose a slightly smaller borehole and protect the wellbore 20 from intrusion of, for example, freshwater aquifers located near the terranean surface 12. The wellbore 20 may than extend vertically downward. This portion of the wellbore 20 may be enclosed by the intermediate casing 35.

Wellbore fluid 50 (for example, a multiphase fluid) flows from the tubular 17 into a wellhead 100, through the multiphase flow meter 110, and to a separation assembly 130, which separates the constituents of the wellbore fluid 50 into, for instance, separate flows of oil, gas, and water. However, as the wellbore fluid 50 flows through the multiphase flow meter 110, the wellbore fluid 50 is still a multiphase mixture of oil, gas, and water. As shown the ML control system 120 is communicably coupled (wired or wirelessly) to the multiphase flow meter 110 in order to receive or otherwise reference flow data produced by the multiphase flow meter 110 by the wellbore fluid 50. In some aspects, the multiphase flow meter 110 is an ultrasonic tomographic multiphase flow meter (UMM) 110 measures the ultrasonic waveforms though transducer pairs of the meter.

For example, because gas and liquid with obvious density and sound velocity difference have well-recognized characteristics, and its non-radioactive and non-intrusive nature, a UMM can be applied in multiphase flow metering. Various experimental mechanisms can achieve some aspects of flow metering, for example, water-cut, void fraction, flow regime detection, etc. However, the combination of the UMM 110 and ML control system 120 can provide for an otherwise undeveloped ML solution of robust multiphase fractions and volumetric flow rates metering.

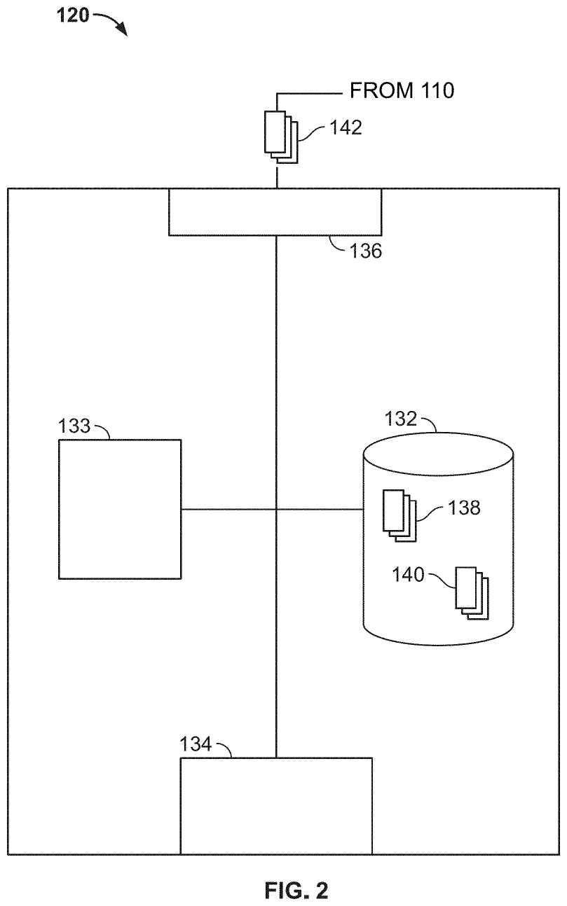

FIG. 2 is a schematic diagram of a computing system that implements the ML control system 120 (structured data processing system) shown in FIG. 1. The ML control system 120, in this example, is coupled to the UMM 110 and capable of receiving or obtaining data from the UMM 110 in the form of waveform data 142. Generally, the ML control system 120 includes a processor-based control system operable to implement one or more operations described in the present disclosure. As shown in FIG. 2, waveform data 142 can be received at the ML control system 120 from the UMM 110 that is fluidly coupled to the flow of the wellbore fluid 50. The waveform data 142, in some aspects, may represent ultrasonic sound speed or tomography metering, or other available phase-cut metering, from the UMM 110.

The ML control system 120 may be any computing device operable to receive, transmit, process, and store any appropriate data associated with operations described in the present disclosure. The illustrated ML control system 120 includes application 133). The application 133 is any type of application that allows the ML control system 120 to request and view content on the ML control system 120. In some implementations, the application 133 can be and/or include a web browser. In some implementations, the application 133 can use parameters, metadata, and other information received at launch to access a particular set of data associated with the ML control system 120. Further, although illustrated as a single application 133, the application 133 may be implemented as multiple applications in the ML control system 120.

The illustrated ML control system 120 further includes an interface 136, a processor 134, and a memory 132. The interface 136 is used by the ML control system 120 for communicating with other systems in a distributed environment—including, for example, the UMM 110—that may be connected to a network. Generally, the interface 136 comprises logic encoded in software and/or hardware in a suitable combination and operable to communicate with, for instance, the UMM 110, a network, and/or other computing devices. Such systems are often referred to in practice as data “historians.” More specifically, the interface 136 may comprise software supporting one or more communication protocols associated with communications such that a network or interface's hardware is operable to communicate physical signals within and outside of the ML control system 120.

Regardless of the particular implementation, “software” may include computer-readable instructions, firmware, wired or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, ABAP, assembler, Perl, Python, .NET, Matlab, any suitable version of 4GL, as well as others. While portions of the software illustrated in FIG. 2 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The processor 134 executes instructions and manipulates data to perform the operations of the ML control system 120. The processor 134 may be a central processing unit (CPU), a blade, an application specific integrated circuit (ASIC), a field-programmable gate array (FPGA), graphics processing unit (GPU), or another suitable component. Generally, the processor 134 executes instructions and manipulates data to perform the operations of the ML control system 120.

Although illustrated as a single memory 132 in FIG. 2, two or more memories may be used according to particular needs, desires, or particular implementations of the ML control system 120. In some implementations, the memory 132 is an in-memory database. While memory 132 is illustrated as an integral component of the ML control system 120, in some implementations, the memory 132 can be external to the ML control system 120. The memory 132 may include any memory or database module and may take the form of volatile or non-volatile memory including, without limitation, magnetic media, optical media, random access memory (RAM), read-only memory (ROM), removable media, or any other suitable local or remote memory component. The memory 132 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the ML control system 120.

The illustrated ML control system 120 is intended to encompass any computing device such as a desktop computer, laptop/notebook computer, wireless data port, smart phone, smart watch, wearable computing device, personal data assistant (PDA), tablet computing device, one or more processors within these devices, or any other suitable processing device. For example, the ML control system 120 may comprise a computer that includes an input device, such as a keypad, touch screen, or other device that can accept user information, and an output device that conveys information associated with the operation of the ML control system 120 itself, including digital data, visual information, or a GUI.

As illustrated in FIG. 2, the memory 132 stores structured or unstructured (e.g. raw text files with no predefined taxonomy) data, including one or more ML models 138 and one or more virtual flow meters 140 (in other words, sensor data for one or more virtual flow meters) as described in more detail herein.

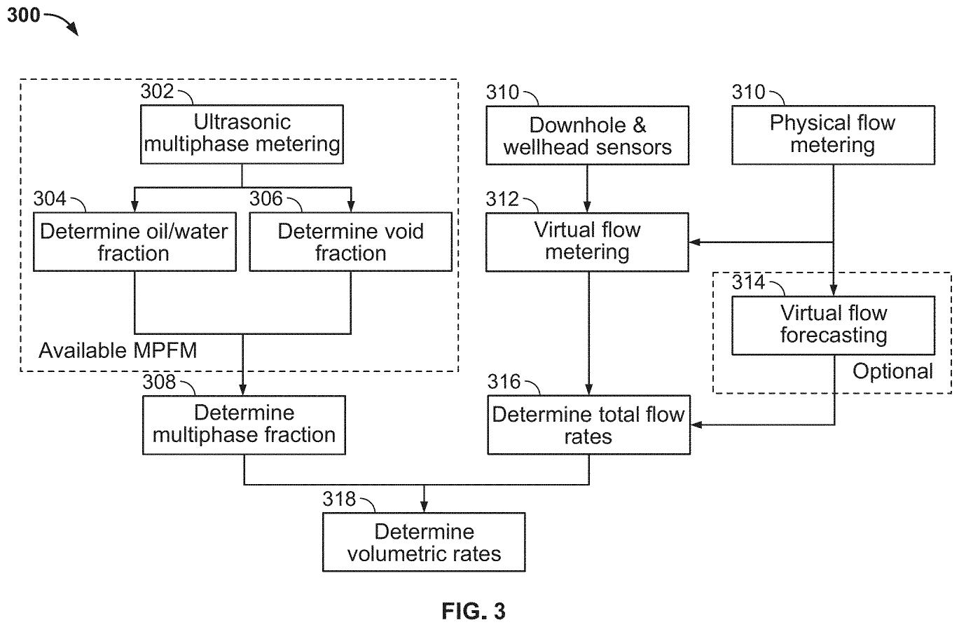

FIG. 3 is a schematic illustration of a workflow 300 for an ML based multiphase flow metering process. In some aspects, the workflow 300 can be executed by or with the well system 10 shown in FIG. 1, including UMM 110 and the ML control system 120.

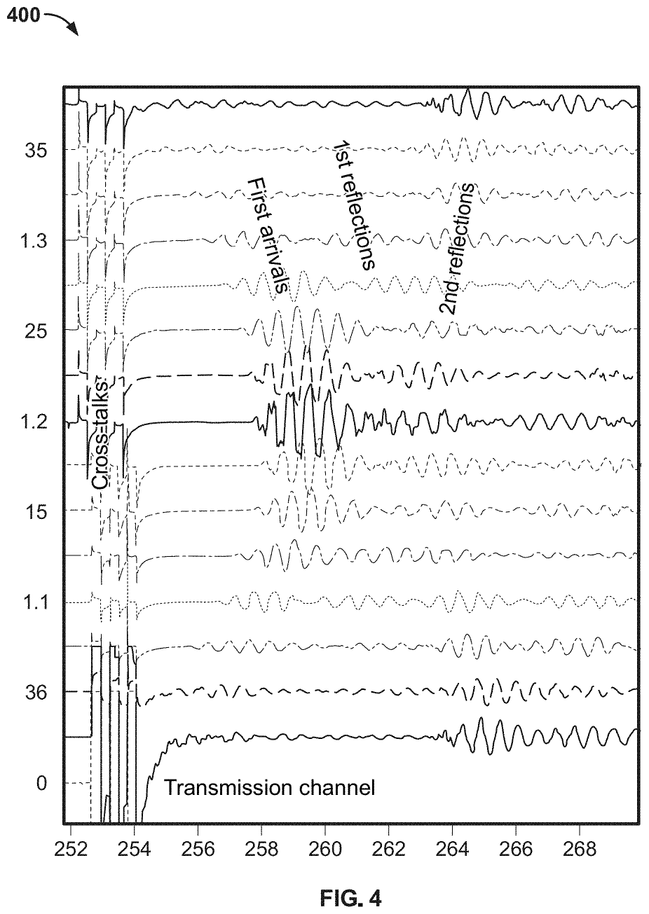

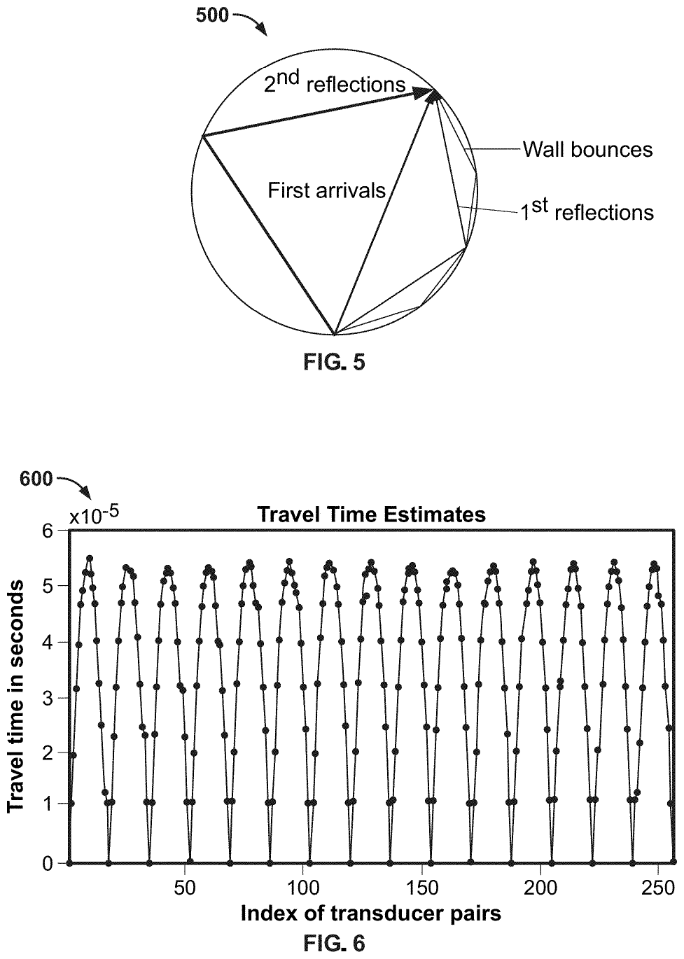

Workflow 300 can include step 302, which includes performing ultrasonic metering of a multiphase fluid flow. For example, as wellbore fluid 50 passes through the UMM 110, the UMM 110 can operate to measure the ultrasonic waveforms though transducer pairs as the wellbore fluid 50 passes there through. Turning briefly to FIG. 4, this figure is a graph 400 that shows measurements of ultrasonic waveforms through transducer pairs of an ultrasonic tomographic multiphase flow meter, such as the UMM 110. As shown in this graph 400, the waveforms can consist of first arrivals, first reflections, and second reflections, which are also shown schematically in a cross-section diagram 500 of FIG. 5.

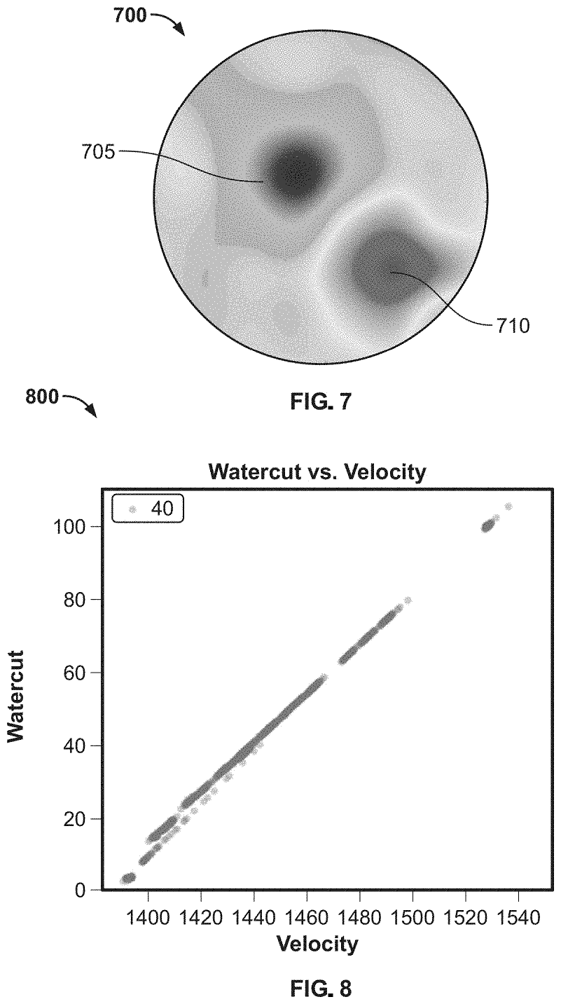

Once the waveforms are obtained by the UMM 110, they can be used in travel time estimations for all transducer pairs of the UMM 110 by the ML control system 120. For example, FIG. 6 shows a graph 600 that shows travel time estimates (on the y-axis, in seconds) for transducer pairs (on the x-axis) of the UMM 110. The ML control system 120 can then execute image processing and inversion algorithms to the estimated travel times to compute a sound velocity profile. FIG. 7 is an image 700 that shows an inversion of a sound velocity profile computed from the travel time estimates of FIG. 6. For example, image 700 represents the inverted sound speed distribution at the cross-section of a pipeline. The sound speed profile is plotted with a low sound speed zone 705 and a high sound speed zone 710, which corresponds to the different phase composition in the flow, for example, water at low speed and oil at high speed. The travel time prediction can be calculated via a forward model such as ray tracing. The non-linear tomographic inversion can be iteratively solved using, for example, the Gauss-Newton method.

Workflow 300 can also include step 304, which includes determining an oil/water fraction (also called water cut). For example, once the ML control system 120 determines the sound velocity profile, the ML control system 120 can determine the oil/water fraction from the sound velocity profile via an ML regression. For example, FIG. 8 is a graph 800 that shows water cut (or oil/water fraction) relative to sound velocity for the wellbore fluid 50. For example, the sound velocity can be a complex function of the water cut in the flow, due to the velocity difference of the two-phase compositions. In an example ML approach, a dataset is collected with the measured velocity profiles and corresponding water cut. Then a regression model is trained from the dataset, to learn the correlation between the water cut and sound velocity profile by using selected model architecture (for example, XGBoost regressor, deep neural network, etc.). The model can then be validated and tested in another dataset for its performance and optimization. Finally, the selected model can be applied to predict water cut in a new dataset where the water cut is unknown.

Workflow 300 can also include step 306, which includes determining a void fraction of the multiphase fluid. For example, the ML control system 120 can execute an ML-based data analysis technique that can be used to determine a cross-sectional void fraction of the multiphase fluid (in other words, wellbore fluid 50) through the energy of the ultrasonic pulse signals of the UMM 110 (or other available phase-cut metering). For example, different void fraction and flow rates can develop different flow patterns, for example, slug flow, churn flow, and bubble flow. Those flow patterns could be characterized by ultrasonic pulse signals.

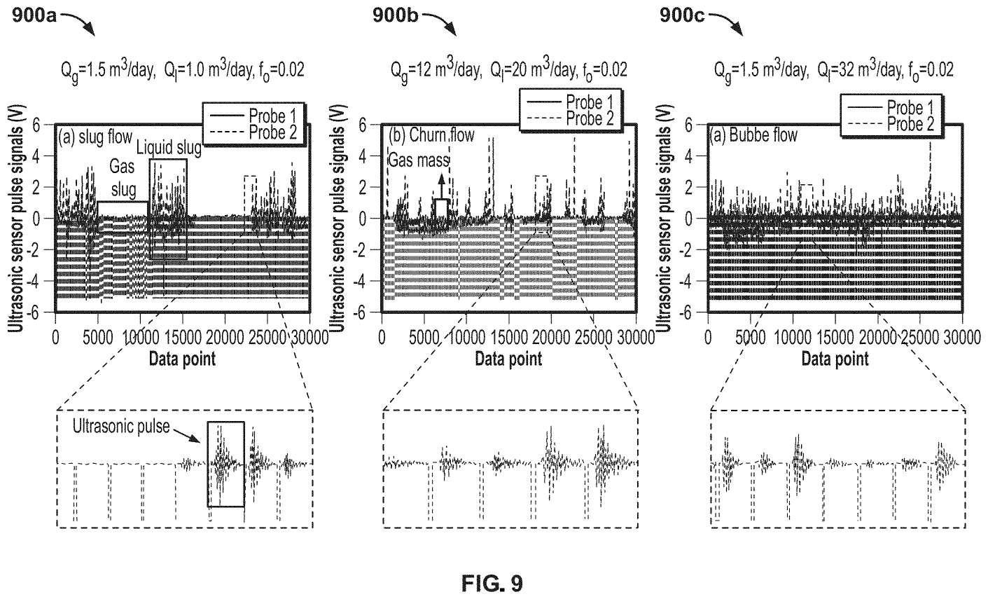

For example, FIG. 9 shows graphs 900a, 900b, and 900c that illustrate ultrasonic sensor pulse signals to characterize flow patterns in a multiphase fluid flow such as wellbore fluid 50. In some aspects, the ML control system 120 extracts and identifies the flow pattern characteristics based on the ultrasonic sensor pulse signals from the UMM 110. In an example, the ML control system computes boxcar time window statistics of the pulse signal, then uses an ML classifier (for example, XGBoost classifier) to classify the flow patterns. At each flow pattern regime, energy (for example, sound pressure) of a received signal relative to a maximum signal is related to void fraction. Therefore, the void fraction can be predicted through an ML data analytics technique, such as, for example, XGBoost regressor.

FIG. 9 (from “Void Fraction Measurement of Oil-Gas-Water Three-Phase Flow Using Mutually Perpendicular Ultrasonic Sensor”, Ren et al., Sensors, 2020) demonstrates the ultrasonic pulse signals from two receivers under typical flow patterns, where obvious differences between the signals confirms the heterogeneous structure of the oil-gas-water three-phase flow. For example, when the flow pattern presents slug flow, the corresponding ultrasonic pulse signals show a pseudo-periodic pattern. The churn flow also shows a pseudo-periodic pattern, but the amplitude is lower than slug flow. The bubble flow shows no significant period, and the received energy is related to the void fraction. Thus, a ML classifier can be trained to identify the signal pattern and predict the corresponding flow regime. Then ML regressors can be trained at each flow regime (or combined model) to learn the correlation between the energy amplitude and void fraction, and make prediction.

In some aspects, the ML control system 120 correlates water and oil fractions and the void fraction to improve the operation envelope with gas. For instance, due to a complex flow structure and interfacial effect, the multiphase flow can form different flow regimes under a combination of gas and liquid volumetric flux. FIG. 13 is a schematic illustration of gas volumetric flux relative to liquid volumetric flux in a multiphase fluid flow and resultant flow regimes. FIG. 13 includes graph 1300 that shows regions of particular flow regimes based on gas volumetric flux relative to liquid volumetric flux. Example illustrations 1305 that shows the particular flow regimes within a conduit are also shown in FIG. 13.

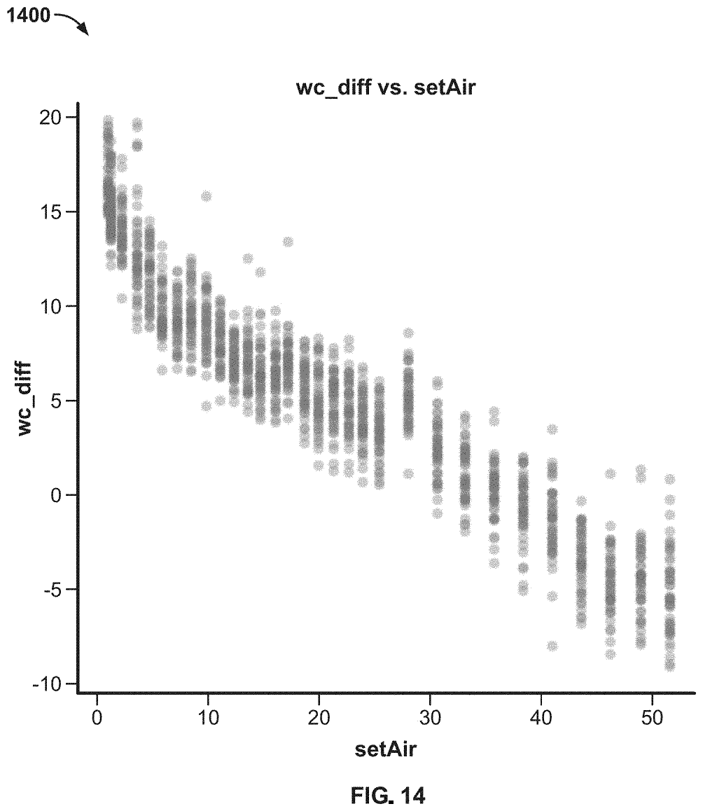

In some aspects, one or more ML models 138 of water/oil and void fraction can be significantly affected by the flow regime of the multiphase fluid (such as wellbore fluid 50). Therefore, in some aspects, the ML control system 120 can correlate water-cut and void fraction to correct the estimation under the particular flow regime of the wellbore fluid 50 to improve operation envelope, especially in circumstances of high gas flow. The difference of estimated water-cut and actual water-cut under varying gas flow rate can be modeled with an ML algorithm (for example, a deep neural network regressor) for the correction of robust water-cut estimation. For example, FIG. 14. shows a graph that illustrates water-oil fraction correction under gas flow rate. Graph 1400, more specifically, shows a difference in estimated water-cut and actual water-cut relative to volumetric gas flow rate in a multiphase fluid, such as wellbore fluid 50.

Workflow 300 can also include step 308, which includes determining a multiphase fraction of the multiphase fluid, such as wellbore fluid 50. For example, the ML control system 120 can determine the multiphase fractions of oil, water, and gas based on the determined water cut (which indicates the water fraction and oil fraction) and the determined void fraction (which indicates the gas fraction). Thus, in the wellbore fluid 50 that passes through the UMM 110, the ML control system 120 calculated fractions of each phase of the wellbore fluid 50 that, as described later, can be used to determine volumetric flow rates of each phase in combination with total flow rates.

Workflow 300 can also include step 310, which includes receiving measurements from downhole and wellhead sensors (for example, pressure, temperature, ESP, etc.). For example, downhole and wellhead sensors can measure data that can be processed to determine a total volumetric flow of a multiphase fluid (such as wellbore fluid 50) that, for example, does not account for the different phase flows.

In some aspects, for example, the total flow rate is desirable in oil and gas production, which might be measured by a flow meter. A physical meter can be used on a per-well basis. However, a flow meter can also be installed at a central location like a manifold so that the production from individual wells are passed through the meter one at a time in a controlled manner.

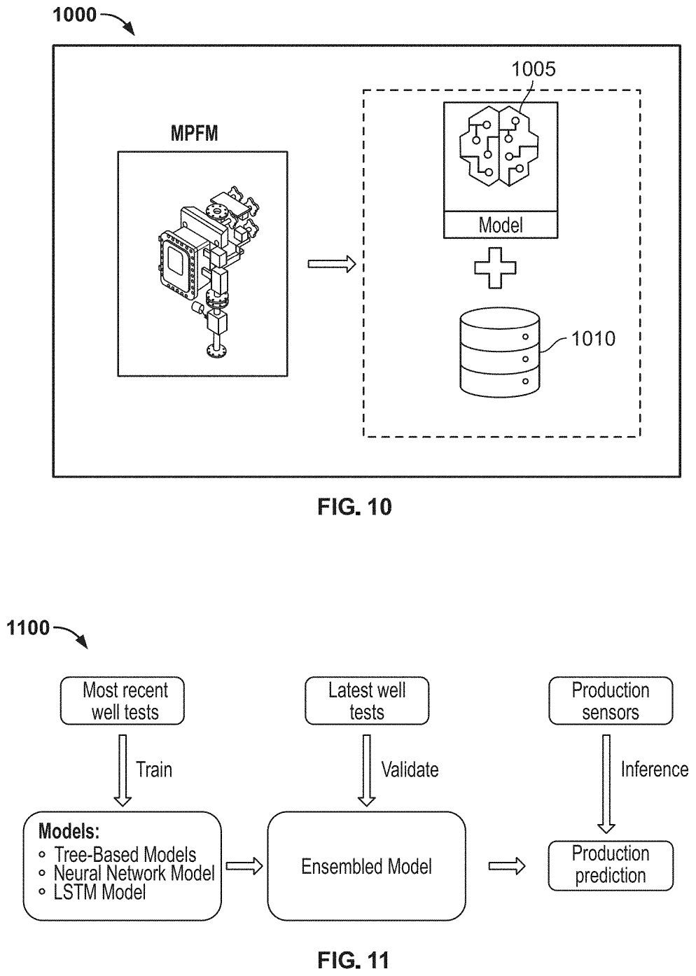

Workflow 300 can also include step 312, which includes generating a virtual flow meter and performing virtual flow metering. For example, the ML control system 120 can utilize the data from both the downhole and wellhead sensors and one or more physical flow meters in a well system to generate a virtual flow meter. An example of a virtual flow meter 1000 generated by the ML control system 120 from a multiphase flow meter (MPFM) (and/or other downhole and wellhead sensor data) is shown in FIG. 10. The virtual flow meter 1000 (and associated methods using a virtual flow meter) can provide a more flexible and economic solution in production (for example, relative to one or many physical flow meters that can be tied to multiple production wells with no separation). In this example, virtual flow meter 1000 comprises a computerized model 1005 that derives the flow rates from other sensor data, for example, wellhead sensors, pipeline sensors. The model 1005 includes flow rate and historical and real-time sensor data 1010.

In some aspects, the virtual flow meter 1000 can be generated by the ML control system 120 through historical data of measured flow rates and other sensor data by utilizing physics formulation and/or advanced data analytics (for example, in an ML approach). Then the flow rate is predicted by the trained model 1005 with production sensor data. In an example implementation, FIG. 11 is a schematic illustration of an ML training architecture 1100. For example, as shown, well test production (flow rate) data and be used to train the model 1005, which can be a tree-based model, a neural network model, or an LSTM (Long Short-Term memory) model. Once trained, the model 1005 is validated by the latest well test production (flow rate) data.

Workflow 300 can also include step 314, which includes performing (optionally) virtual flow forecasting. For example, the optional virtual flow forecasting is a model that can forecast the future flow rates based on the historical flow rates, instead of using sensors data for instantaneous prediction as in virtual flow metering. The forecasted flow rate may be combined with VFM prediction to improve the accuracy of result.

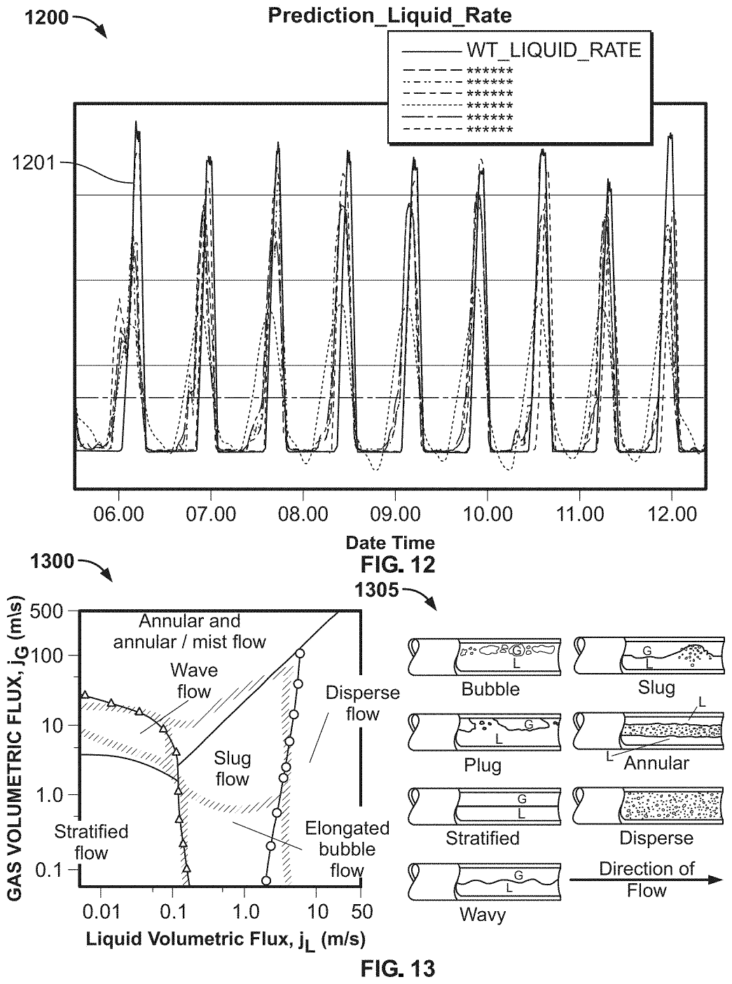

Workflow 300 can also include step 316, which includes determining total flow rates for the multiphase fluid. For example, the validated model 1005 can then be used by the ML control system 120 to predict production flow rate data (for example, of wellbore fluid 50) correlated with production sensor data. As shown in FIG. 12, for example, the virtual flow meter 1000 can predict production volumetric flow rate of the multiphase fluid (for example, wellbore fluid 50) over time. FIG. 12 includes a graph 1200 that shows several predicted production flow rates over time. Graph 1200 demonstrates the physical measurements of liquid flow rate as ground truth 1201 to compare with the predictions from different ML models (dash and dotted lines)—RandomForest (red dash line), GradientBoost (yellow dash line), ExtraTree (green dash line), ElasticnetCV (brown dash line), Deep Neural Network (pink dotted line), and LSTM (black dotted line).

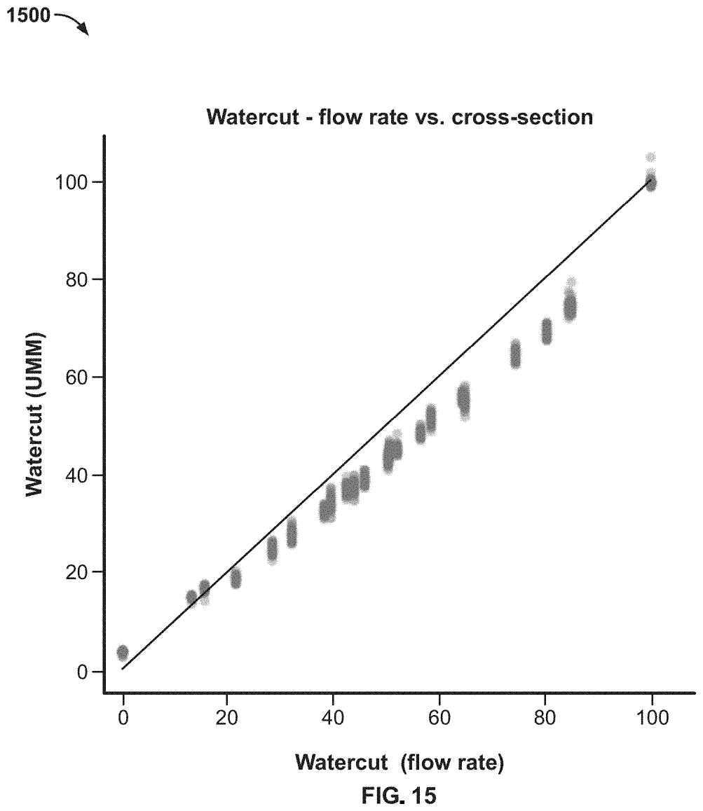

Workflow 300 can also include step 318, which includes determining volumetric flow rates of the different phases of the multiphase fluid. For example, once the ML control system 120 determines the total flow rates of liquid and gas in the multiphase flow in step 316 and the fractions of each phase in step 308, the ML control system 120 can use these determinations to then calculate or determine the particular volumetric flow rate of the oil, water, and gas in the multiphase fluid. For example, it can be of interest to estimate individual volumetric flow rates in production flow metering of, for example, wellbore fluid 50. The volumetric flow rates can be strongly related to the estimation of cross-sectional water/oil fraction and void fraction via the ultrasonic multiphase flow metering of UMM 110. However, there can be a difference in cross-sectional water-cut fraction and volumetric flow fraction of water due to superficial velocity, which can be corrected by the ML control system 120 with an ML model. FIG. 15 is a graph 1500 that illustrates cross-sectional water-cut fraction relative to volumetric flow fraction.

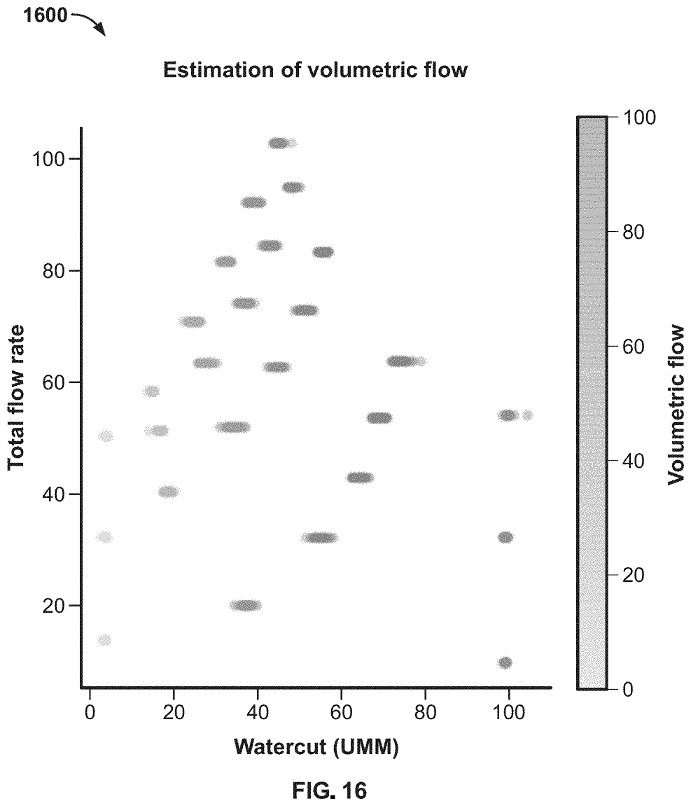

Once corrected, the ML control system 120 can estimate volumetric flow rates of the multiphase fluid fractions with the total flow rates (from 316) and cross-sectional water/oil and void fractions (from 308). The estimation can be based on an ML model 138, such as an ML analytic model such as Random Forests regressor. FIG. 16 is a graph 1600 that illustrates an estimation of volumetric flow rates in step 318. For example, as shown in graph 1600, total flow rate of the multiphase fluid is shown on the left-side y-axis, while volumetric flow is shown on the right-side color bar (plotted by color scatter dots). Water-cut is shown on the x-axis.

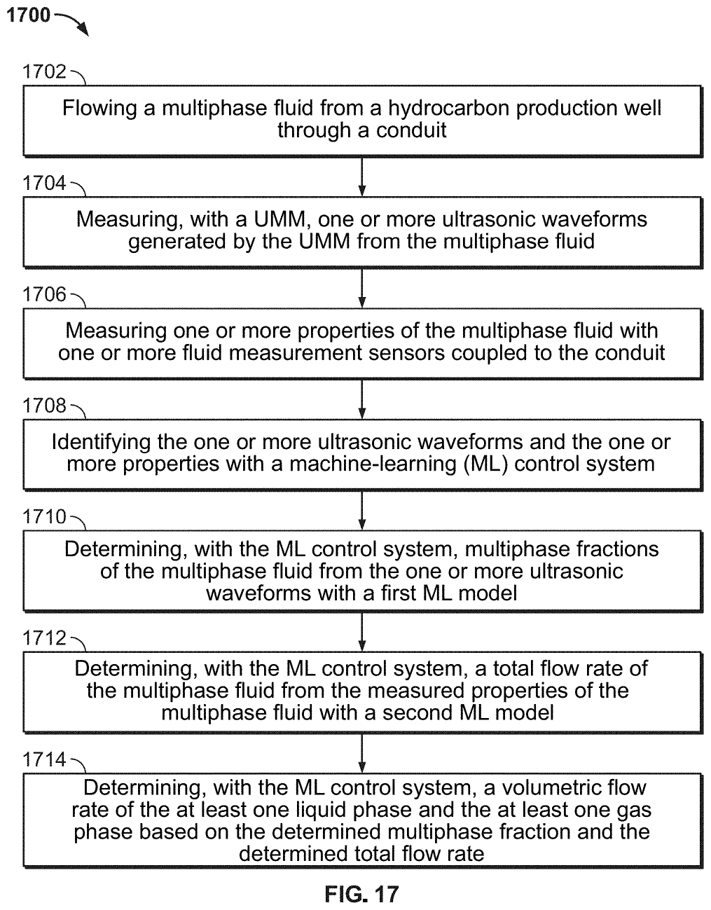

FIG. 17 is a flowchart that illustrates an example method 1700 for determining properties of a multiphase fluid flow according to the present disclosure. In some aspects, all or a part of method 1700 can be performed with the well system 10 shown in FIG. 1, including the UMM 110 and ML control system 120. Method 1700 can being at step 1702, which includes flowing a multiphase fluid from a hydrocarbon production well through a conduit. In some aspects, the multiphase fluid can be a hydrocarbon multiphase fluid that includes, for example a liquid phase or a gas phase (or both). In some aspects, the liquid phase can include both water and oil.

Method 1700 can continue at step 1704, which includes measuring, with a UMM, one or more ultrasonic waveforms generated by the UMM from the multiphase fluid. For example, an ultrasonic tomographic multiphase flow meter or other non-radioactive and non-intrusive flow measurement device can be coupled within the conduit such that the multiphase fluid flows through the UMM. The UMM can measure or detect ultrasonic waveforms though transducer pairs of the UMM.

Method 1700 can continue at step 1706, which includes measuring one or more properties of the multiphase fluid with one or more fluid measurement sensors (for example, pressure, temperature, ESP, etc.) coupled to the conduit. For example, physical flow meters (different than the UMM) can also be physically and fluidly coupled with the conduit to make flow measurements of the total volumetric flow of the multiphase fluid flow. Other sensors that can measure fluid properties from which, for example, a total volumetric flow can be determined are also included in step 1706.

Method 1700 can continue at step 1708, which includes identifying the one or more ultrasonic waveforms and the one or more properties with a machine-learning (ML) control system. For example, an ML control system (for example, a microprocessor based control system that executes one or more ML models or data analytics) can be communicably coupled to the UMM and the one or more fluid measurement sensors (for example, either in real time or subsequent to flow of the multiphase fluid through the conduit). The measured ultrasonic waveforms and the one or more properties can be received at or otherwise exposed to the ML control system.

Method 1700 can continue at step 1710, which includes determining, with the ML control system, multiphase fractions of the multiphase fluid from the one or more ultrasonic waveforms with a first ML model. For example, the ML control system can provide an ML-based estimation of the cross-sectional water/oil fraction through, for instance, ultrasonic sound speed or tomography metering from the UMM, using ML image processing and inversion algorithms applied to estimated travel times between transducer pairs to compute a sound velocity profile. Further, the ML control system can provide an ML-based estimation of a cross-sectional void fraction through the measured energy of the ultrasonic pulse signals corrected according to fluid flow regime of the multiphase fluid.

Method 1700 can continue at step 1712, which includes determining, with the ML control system, a total flow rate of the multiphase fluid from the measured properties of the multiphase fluid with a second ML model. For example, the total flow rate can be estimated with a virtual flow meter generated by the ML control system, which can be built through historical data of measured flow rates of the multiphase fluid through sensor data by utilizing physics formulation and/or advanced data analytics.

Method 1700 can continue at step 1714, which includes determining, with the ML control system, a volumetric flow rate of the at least one liquid phase and the at least one gas phase based on the determined multiphase fraction and the determined total flow rate. For example, through a ML model (such as Random Forests regressor), the ML control system can estimate the volumetric flow rates of the liquid fraction (and each liquid fraction in the case of oil and water) as well as the gas fraction according to the previously determined or estimated total flow rates and cross-sectional water/oil and void fractions, respectively. In some aspects, the ML control system corrects the estimated individual volumetric flow rates of the liquid fractions based on a superficial velocity of the multiphase fluid flow.

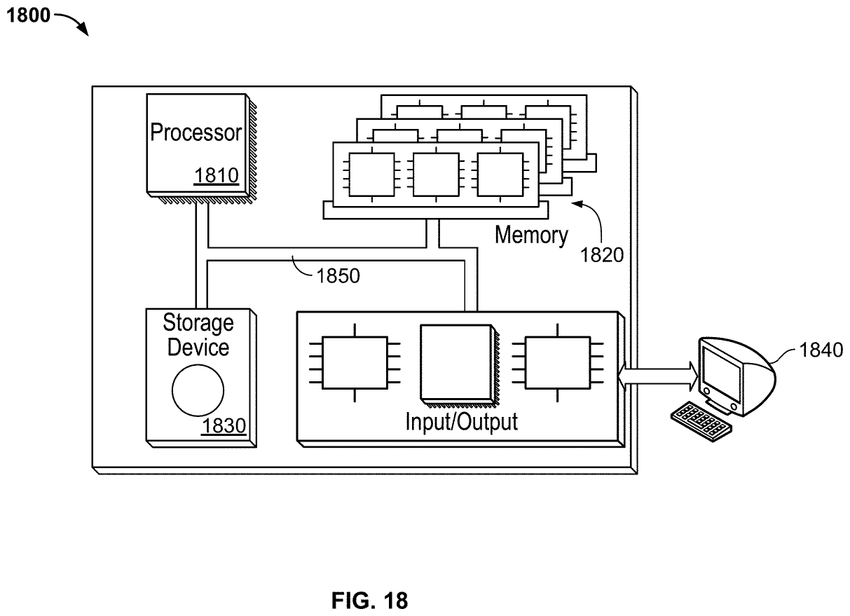

FIG. 18 is a schematic illustration of an example controller 1800 (or control system) for determining properties of a multiphase fluid flow. For example, all or parts of the controller 1800 can be used for the operations described previously, for example as or as part of the ML control system 120. The controller 1800 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 1800 includes a processor 1810, a memory 1820, a storage device 1830, and an input/output device 1840. Each of the components 1810, 1820, 1830, and 1840 are interconnected using a system bus 1850. The processor 1810 is capable of processing instructions for execution within the controller 1800. The processor may be designed using any of a number of architectures. For example, the processor 1810 may be a CISC (Complex Instruction Set Computers) processor, a RISC (Reduced Instruction Set Computer) processor, or a MISC (Minimal Instruction Set Computer) processor.

In one implementation, the processor 1810 is a single-threaded processor. In another implementation, the processor 1810 is a multi-threaded processor. The processor 1810 is capable of processing instructions stored in the memory 1820 or on the storage device 1830 to display graphical information for a user interface on the input/output device 1840.

The memory 1820 stores information within the controller 1800. In one implementation, the memory 1820 is a computer-readable medium. In one implementation, the memory 1820 is a volatile memory unit. In another implementation, the memory 1820 is a non-volatile memory unit.

The storage device 1830 is capable of providing mass storage for the controller 1800. In one implementation, the storage device 1830 is a computer-readable medium. In various different implementations, the storage device 1830 may be a floppy disk device, a hard disk device, an optical disk device, a tape device, flash memory, a solid state device (SSD), or a combination thereof.

The input/output device 1840 provides input/output operations for the controller 1800. In one implementation, the input/output device 1840 includes a keyboard and/or pointing device. In another implementation, the input/output device 1840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A well system, comprising:
a conduit configured to flow a multiphase fluid from a hydrocarbon production well to or on a terranean surface, the multiphase fluid comprised of at least one of a liquid phase or a gas phase;
an ultrasonic tomographic multiphase flow meter (UMM) fluidly coupled to the conduit to receive the multiphase fluid there through;
one or more fluid measurement sensors positioned to measure one or more properties of the multiphase fluid; and
a machine-learning (ML) control system that comprises at least one hardware processor operable to execute instructions stored on a tangible, non-transitory memory to perform operations comprising:
(i) identifying one or more ultrasonic waveforms generated by the UMM from the multiphase fluid;
(ii) identifying measured properties of the multiphase fluid from the one or more fluid measurement sensors;
(iii) determining multiphase fractions of the multiphase fluid from the one or more ultrasonic waveforms with a first ML model;
(iv) determining a total flow rate of the multiphase fluid from the measured properties of the multiphase fluid with a second ML model; and
(v) determining a volumetric flow rate of the at least one of the liquid phase or the gas phase based on the determined multiphase fraction and the determined total flow rate.

2. The well system of claim 1, wherein the liquid phase comprises a water phase and an oil phase.

3. The well system of claim 1, wherein the second ML model comprises a virtual flow meter model.

4. The well system of claim 3, wherein the operation (iv) comprises predicting the total flow rate with the virtual flow meter model based on the measured properties of the multiphase fluid.

5. The well system of claim 3, wherein the virtual flow meter model comprises an ML trained model from historical measured flow rates of the multiphase fluid and historical properties of the multiphase fluid measured by the one or more fluid measurement sensors.

6. The well system of claim 1, wherein the operation (iii) comprises:
determining a liquid fraction of the liquid phase based at least in part on a sound velocity profile of the multiphase fluid determined from the one or more ultrasonic waveforms with the first ML model; and
determining a void fraction of the gas phase based at least in part on the one or more ultrasonic waveforms with the first ML model.

7. The well system of claim 6, wherein the operation of determining the void fraction comprises predicting the void fraction based on a flow regime of the multiphase fluid with the first ML model.

8. The well system of claim 7, wherein the operations further comprise correlating the liquid fraction and the void fraction based on the flow regime of the multiphase fluid to correct the determined liquid and gas fractions.

9. The well system of claim 6, wherein the determined liquid fraction comprises a water cut of the multiphase fluid.

10. The well system of claim 1, wherein the operations further comprise correcting an estimated volumetric flow rate of the liquid phase and an estimate of volumetric flow rate of the gas phase with a third ML model to determine the volumetric flow rate of the liquid phase and the gas phase.

11. The well system of claim 10, wherein the operation of correcting the estimated volumetric flow rate of the liquid phase and an estimate of volumetric flow rate of the gas phase comprises using the third ML model to correct the estimated volumetric flow rates based at least in part on a superficial velocity of the multiphase fluid.

12. A method, comprising:
flowing a multiphase fluid from a hydrocarbon production well through a conduit, the multiphase fluid comprised of at least one of a liquid phase or a gas phase;
measuring, with an ultrasonic tomographic multiphase flow meter (UMM) fluidly coupled to the conduit, one or more ultrasonic waveforms generated by the UMM from the multiphase fluid;
measuring one or more properties of the multiphase fluid with one or more fluid measurement sensors coupled to the conduit;
identifying the one or more ultrasonic waveforms and the one or more properties with a machine-learning (ML) control system that comprises at least one hardware processor operable to execute instructions stored on a tangible, non-transitory memory;
determining, with the ML control system, multiphase fractions of the multiphase fluid from the one or more ultrasonic waveforms with a first ML model;
determining, with the ML control system, a total flow rate of the multiphase fluid from the measured properties of the multiphase fluid with a second ML model; and
determining, with the ML control system, a volumetric flow rate of the at least one of the liquid phase or the gas phase based on the determined multiphase fraction and the determined total flow rate.

13. The method of claim 12, wherein the liquid phase comprises a water phase and an oil phase.

14. The method of claim 12, wherein the second ML model comprises a virtual flow meter model.

15. The method of claim 14, wherein determining, with the ML control system, the total flow rate of the multiphase fluid comprises:
predicting, with the ML control system, the total flow rate with the virtual flow meter model based on the measured properties of the multiphase fluid.

16. The method of claim 14, wherein the virtual flow meter model comprises an ML trained model from historical measured flow rates of the multiphase fluid and historical properties of the multiphase fluid measured by the one or more fluid measurement sensors.

17. The method of claim 12, wherein determining, with the ML control system, multiphase fractions of the multiphase fluid comprises:
determining, with the ML control system, a liquid fraction of the liquid phase based at least in part on a sound velocity profile of the multiphase fluid determined from the one or more ultrasonic waveforms with the first ML model; and
determining, with the ML control system, a void fraction of the gas phase based at least in part on the one or more ultrasonic waveforms with the first ML model.

18. The method of claim 17, wherein determining the void fraction comprises predicting the void fraction based on a flow regime of the multiphase fluid with the first ML model.

19. The method of claim 18, further comprising correlating, with the ML control system, the liquid fraction and the void fraction based on the flow regime of the multiphase fluid to correct the determined liquid and gas fractions.

20. The method of claim 17, wherein the determined liquid fraction comprises a water cut of the multiphase fluid.

21. The method of claim 12, further comprising correcting an estimated volumetric flow rate of the liquid phase and an estimate of volumetric flow rate of the gas phase with a third ML model to determine the volumetric flow rate of the liquid phase and the gas phase.

22. The method of claim 21, wherein correcting the estimated volumetric flow rate of the liquid phase and an estimate of volumetric flow rate of the gas phase comprises using the third ML model to correct the estimated volumetric flow rates based at least in part on a superficial velocity of the multiphase fluid.

23. An apparatus comprising a tangible, non-transitory computer-readable media that comprises instructions operable, when executed by one or more hardware processors, to cause the one or more hardware processors to perform operations comprising:
identifying one or more ultrasonic waveforms generated by an ultrasonic tomographic multiphase flow meter (UMM) from a multiphase fluid that comprises at least one of a liquid phase or a gas phase;
identifying measured properties of the multiphase fluid from the one or more fluid measurement sensors;
determining multiphase fractions of the multiphase fluid from the one or more ultrasonic waveforms with a first ML model;
determining a total flow rate of the multiphase fluid from the measured properties of the multiphase fluid with a second ML model; and
determining a volumetric flow rate of the liquid phase and the gas phase based on the determined multiphase fraction and the determined total flow rate.

24. The apparatus of claim 23, wherein the liquid phase comprises a water phase and an oil phase.

25. The apparatus of claim 23, wherein the second ML model comprises a virtual flow meter model.

26. The apparatus of claim 25, wherein the operation (iv) comprises predicting the total flow rate with the virtual flow meter model based on the measured properties of the multiphase fluid.

27. The apparatus of claim 25, wherein the virtual flow meter model comprises an ML trained model from historical measured flow rates of the multiphase fluid and historical properties of the multiphase fluid measured by the one or more fluid measurement sensors.

28. The apparatus of claim 23, wherein the operation (iii) comprises:
determining a liquid fraction of the liquid phase based at least in part on a sound velocity profile of the multiphase fluid determined from the one or more ultrasonic waveforms with the first ML model; and
determining a void fraction of the gas phase based at least in part on the one or more ultrasonic waveforms with the first ML model.

29. The apparatus of claim 28, wherein the operation of determining the void fraction comprises predicting the void fraction based on a flow regime of the multiphase fluid with the first ML model.

30. The apparatus of claim 29, wherein the operations further comprise correlating the liquid fraction and the void fraction based on the flow regime of the multiphase fluid to correct the determined liquid and gas fractions.

31. The apparatus of claim 28, wherein the determined liquid fraction comprises a water cut of the multiphase fluid.

32. The apparatus of claim 23, wherein the operations further comprise correcting an estimated volumetric flow rate of the liquid phase and an estimate of volumetric flow rate of the gas phase with a third ML model to determine the volumetric flow rate of the liquid phase and the gas phase.

33. The apparatus of claim 32, wherein the operation of correcting the estimated volumetric flow rate of the liquid phase and an estimate of volumetric flow rate of the gas phase comprises using the third ML model to correct the estimated volumetric flow rates based at least in part on a superficial velocity of the multiphase fluid.
